(19) United States
(12) Patent Application Publication
(10) Pub. No.: US 2016/0203089 A1
(43) Pub. Date: Jul. 14, 2016

(54) EXPANDER DATA ROUTING

(71) Applicant: Hewlett Packard Enterprise Development LP, Houston, TX (US)

(72) Inventors: Balaji Natrajan, Houston, TX (US); Sohail Hameed, Houston, TX (US); Pruthviraj Herur Puttaiah, Houston, TX (US)

(21) Appl. No.: 14/913,835

(22) PCT Filed: Aug. 27, 2013
(86) PCT No.: PCT/US2013/056768

§ 371 Date: Feb. 23, 2016

(51) Int. Cl. G06F 12/14

(52) U.S. Cl. CPC G06F 12/1483; G06F 2212/1052

(57) ABSTRACT

A route table that includes entries of destination identifiers to indicate address information of corresponding destination devices connected to expanders, PHY identifiers to indicate destination devices connected to corresponding PHYs of the expanders, and zone group information to indicate permission associated with the destination devices. A zone set table comprising zone set entries that include zone groups associated with the PHY identifiers. A route management module to check whether zone groups of each zone set of the zone set table has permission to access any of the zone groups of other zone sets, and if any of the zone groups of each zone set of the zone set table does not have permission to access any of the zone groups of other zone sets, then remove from the route table all the destination identifiers corresponding to that zone group.

### BACKGROUND

Storage networks facilitate communication between storage resources and computer devices. In one example of a storage network, Serial attached small computer system interface (SAS) provides a communications protocol for enabling communications between computer devices. According to the SAS protocol specification, SAS devices include initiators, targets, and expanders. Initiators may include devices that begin a SAS data transfer, while targets may be devices to which initiators transfer data. Expanders may include devices that facilitate data transfer between multiple initiators and multiple targets. The SAS protocol utilizes a point-to-point bus topology. Therefore, if initiators are required to connect to multiple targets, direct connections may be established between initiators and each individual target to facilitate each individual data transfer between the initiators and each individual target. Expanders may manage connections and data transfer between multiple initiators and multiple targets. A SAS fabric may include a network of initiators, targets and expanders.

### BRIEF DESCRIPTION OF THE DRAWINGS

Certain examples are described in the following detailed description and in reference to the drawings; in which:

FIG. 1 is an example block diagram of a system with an expander to route data in accordance with the techniques of the present application;

FIG. 2 is another example block diagram of a system with an expander to route data in accordance with the techniques of the present application;

FIG. 3 is an example process flow diagram of a method for the expander of FIG. 2 to route data in accordance with the techniques of the present application;

FIG. 4 is a diagram of route information for the expander of FIG. 2 and FIG. 3 to route data in accordance with the techniques of the present application; and

FIG. 5 is an example block diagram showing a non-transitory, computer-readable medium that stores instructions for operating an expander to route data in accordance with the techniques of the present application.

### DETAILED DESCRIPTION

A SAS fabric may include a network of initiators, targets and expanders configured to communicate according to the SAS protocol specification. For instance, a SAS fabric may comprise initiators configured as devices such as hosts or server computers that may communicate with targets configured as devices such as storage subsystems. In some cases, expanders may receive from initiators requests to establish connections with targets to exchange data with the targets. In a SAS fabric or environment, expanders, initiators and targets may include logical communication ports comprised of PHYs which are physical communication devices or structures to provide connection and communication means for transmitting and receiving data through expanders and between initiators and targets. Expanders may receive from initiators connection requests to establish connections for communication to route data through the expanders and between initiators and targets. The expanders may respond by checking a route table with address information associated with the targets that identify PHYs associated with the targets.

When expanders become operational upon power up or upon a change in the topology of the SAS fabric, the expanders perform a discovery process or cycle to determine or discover all the devices including other expanders, initiators, and targets that are connected to each other as part of the topology. At the end of this discovery process or cycle, the expanders generate a route table. The route table includes information that allows the expanders to route data in response to requests or commands directed or intended to the targets or destination devices that are not directly attached to the expanders. The route table includes entries for all the indirectly attached destination devices that it discovers during the discovery process. However, a SAS fabric may be connected to large numbers of devices including expanders and switches which may result in a corresponding large size route tables that may require large memory resources to support.

In one example, a route table includes three columns: 1) destination address of destination devices including targets and initiators 2) PHY identifiers of the expander associated with the destination devices 3) zone group information related to permission or access of the destination devices. For a given destination device, the PHY identifiers represents PHYs of the expander through which the data or traffic could be routed, and zone group is the zone group of the PHY to which the destination device is connected. There is one entry in the route table for each and every destination device that is discovered by the expander. Storage networks such as SAS fabrics may comprise storage enclosures that may support or host large number of storage resources such as disk drives, switches with large number of ports, and switches stacked together which may cause the size of SAS fabrics to increase dramatically. As a result, the size of route tables may also increase dramatically which may require corresponding large memory resources to support the increased size of the route tables.

The present application describes techniques that may help manage or reduce the number of entries in the route table thereby allowing expanders to make an efficient use of their memory resources and allowing large size networks such as a SAS fabric. For example, described is an expander with a route management module coupled to a route table and a zone set table for managing routing between destination devices including targets and initiators. The route table includes information to route data between destination devices including initiators and targets. The route table includes entries of destination identifiers to indicate address information of corresponding destination devices connected to expanders, PHY identifiers to indicate destination devices connected to corresponding PHYs of the expander, and zone group information to indicate permission associated with the destination devices. The zone set table includes zone set entries that include zone groups associated with the PHY identifiers. The route management module is configured to check whether zone groups of each zone set of the zone set table has permission to access any of the zone groups of other zone sets. If any of the zone groups of each zone set of the zone set table does not have permission to access any of the zone groups of other zone sets, then the route management module removes from the route table all the destination identifiers corresponding to that zone group.

In some examples, the route management module may be configured to respond to requests from initiators to receive data from the initiators and to route the received data through the expanders and to store the data to the targets and respond to requests from initiators to retrieve data from the targets and to route the retrieved data through the expanders and to return the retrieved data back to the initiators. The route management module may be configured to identify targets, initiators and other expanders connected to PHYs of the expander and to store the identification information to the route table. The route management module may be configured to generate a permission table that includes assignment of zone group information to targets that identify initiators that are granted permission to access targets. The route management module may be configured to generate PHY identifiers that represent PHYs of the expanders through which data is to be routed between targets and initiators.

In this manner, these techniques of the present application may help manage and reduce the number of entries in the route table thereby allowing expanders to make an efficient use of their memory resources.

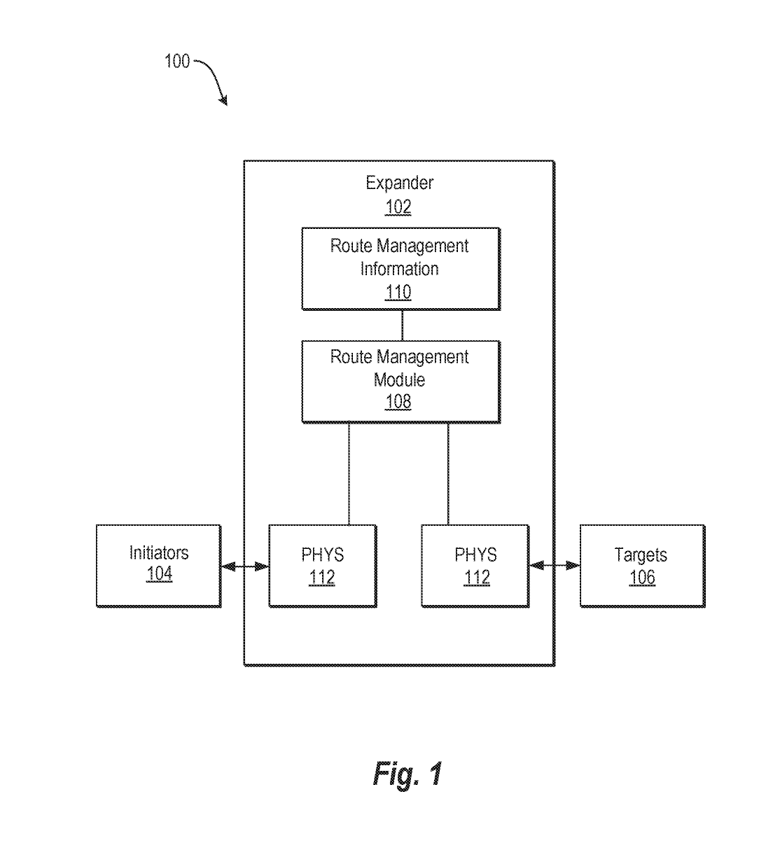

FIG. 1 is an example block diagram of a system 100 comprising an expander 102 configured to route data through the expander and between initiators 104 and targets 106 in accordance with the techniques of the present application.

The expander 102 includes a route management module 108 along with route information module 110 configured to route data through the expander and between initiators 104 and targets 106. The route management module 108 may provide or generate route information module 110 based on a discovery process that includes discovering or determining destination devices such as initiators 104 and targets 106 as well as other expanders directly or indirectly connected to the expander. The expander 102 includes PHYs 112 which provide communication interfaces to facilitate network communication with the expander and between initiators 104 and targets 106. The system 100 may be configured to operate as a storage network such as a SAS fabric with devices such as expander 102, initiators 104 and targets 106 being SAS enabled to allow them to communicate with each other and over the SAS fabric in accordance with the SAS specification and protocols. However, it should be understood that system 100 may be configured in accordance with other network specifications and protocols such as Ethernet and the like.

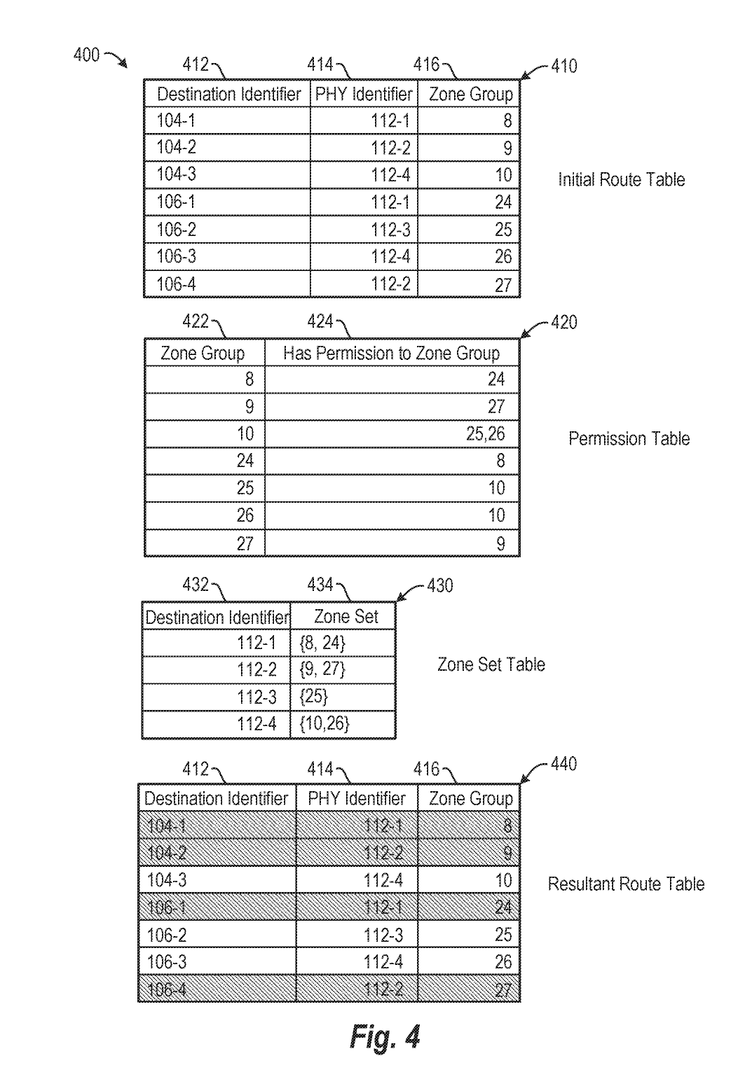

As explained in further detail below, expander 102 may generate route information module 120 such as route information 400 as shown in relation to the example of FIG. 4. The route management module 108 is configured to generate route information 400 that includes initial route table 410 which is based on information gathered as a result of the discovery process to determine the destination devices including initiators and targets connected to the expander. The route management module 108 is configured to also generate permission table 420 which is based in permission or access information provided by a user or administrator and include generation of zone groups and assignment of the zone groups to the destination devices as desired. The route management module 108 is also configured to generate zone set table 430 which includes the expander grouping zone groups of all the destination devices discovered that route data through the PHYs of the expander of PHY. In one example, route management module 108 defines permission or access to a zone set if it has access to at least one of the zone groups in another zone set. If the given zone group belongs to a zone set, then it is said to have access to the zone set, since a zone group always has access to itself.

The route management module 108 is configured to process route information 400 to manage the entries of the route table. For example, route management module 108 is configured to check the first zone set, and for every zone group in that zone set, check to see if the zone group has access to any of the other zone sets. If so, then route management module 108 may enter into the route table all the destination devices corresponding to that zone group. If on the other hand, the zone group has no access to any of the other zone sets, then route management module 108 may drop or remove all the destination devices corresponding to that zone group from the route table. In this manner, the techniques of the present application help manage or reduce the number of entries in the route table thereby allowing expanders to make an efficient use of their memory resources, as explained in further detail below.

The initiators 104 may include or be configured to operate as data processing devices capable of generating requests for establishing connections for communications including exchanging data with other devices over the network or fabric of system 100. The initiators 104 may be capable of generating multiple connection requests sent to expander 102 and directed to storage resources associated with multiple targets 106. The Initiators 104 may comprise hosts or server computers with array controllers to enable access and communicate with other devices on the fabric of system 100. The array controllers may comprise storage controllers such as disk array controllers which may manage physical disk drives and may present them to the servers as logical units. In some examples, array controllers may implement redundant array of independent disks (RAID) functionality and may be referred to as RAID controllers.

The targets 106 may include or be configured to operate as data processing devices capable of communication with expander 102 and manage storage resources with functionality for storage of data and for subsequent retrieval by initiators 104 or other devices. For example, targets 106 may include storage resources as storage drives, such as disk drives, solid state drives, and the like.

The expander 102 is shown comprising route management module 108 which is configured to manage the operation of expander communication with initiators 104 and targets 106 as well as other expanders of the network or fabric of system 100.

The route management module 108 may include functionality to manage PHYs 112 to provide hardware and software interfaces for establishing connections for communication with initiators 104 and targets 106 and other expanders. The expander 102 may form ports which may include one or more PHYs 112 that may comprise SAS protocol structures with transceivers for exchanging data and requests or commands between the expander and initiators 104 and targets 106 and other expanders.

The route management module 108 may include functionality to perform a discovery process of system 100 sometimes referred to as a self-configuration process of as part of a SAS environment or fabric. For example, upon boot up or power up of expander 102 or a change in the topology such as an addition, change or deletion of devices connected to the topology, route management module 108 may proceed to discover or check for devices connected attached to expander 102 as part of the SAS topology or SAS fabric. The route management module 108 may send discover commands, such as SAS discover commands, to devices and wait for responses from devices attached to expander 102, such as target devices, initiator devices as well as other expanders, to discover whether such devices are attached to expander 102 In one example, route management module 108 may perform the discovery process and discover whether one or more initiators 104, targets 106 or other expanders are directly or indirectly connected to PHYs 112 of expander 102.

In another example, route management module 108 may be configured to perform the discovery process by further checking for devices attached to expander 102, such as other expanders, until the process determines that it has reached end devices such as initiators 104 or targets 106. The route management module 108 may determine or discover the destination addresses of destination devices such as targets 106 connected to expander 102. The route management module 108 may use the destination addresses to establish connections for communication to route data in response to connection requests through from initiators 104 and through expander 102 and to targets 106. The route management module 108 may store the destination addresses of targets 106 associated PHYs into a route table for subsequent use in routing data through expander and between initiators 104 and targets 106.

The route management module 108 is configured to respond to requests from initiators 104 to store data to targets and retrieve data from targets. For example, to illustrate, it may be assumed that one of initiators 104 desires to communicate with one of targets 106. In this case, the initiator 104 proceeds to send expander 102 a request or command to establish or open a connection for communication to route data through expander and between the initiator and target. In one example, the request may include a command to exchange data between one of the initiators 104 and one of the targets 106. The route management module 108 may respond by examining route information from information module 110 such as from a route table to determine the PHY associated with the connection and corresponding destination address to route data between the PHY 112 associated with initiator 104 and the PHY 112 associated with target 106. In one example, expander 102 may receive a request from one of initiator 104 to receive data from the initiator and to route the received data through an expander 102 and to store the data to the target 106. The route management module 108 may also be configured to respond to requests from initiators 104 to retrieve data from targets 106 and to route the retrieved data through the expanders and to return the retrieved data back to the initiators 104.

The system 100 of FIG. 1 shows one example of a storage network configured as a SAS fabric with an expander 102 for establishing connections and routing data through the expander and between destination devices including initiators 104 and targets 106. However, it should be understood that this configuration is for illustrative purposes and that a different number and arrangement of devices may be employed to implement the techniques of the present application. For example, system 100 may include a plurality of expanders to establish connections between initiators 104 and targets 106 to form multiple path topologies. The system 100 is described in relation to a storage network such as SAS fabric comprising expander 102 configured to communicate with initiators 104 and targets 106 which are capable of implementing the SAS protocol specification. However, the techniques of the present application may employ other protocols such as Fibre Channel, Ethernet and the like. The functionality of the components of system 100, such as route management module 108, may be implemented in hardware, software or a combination thereof.

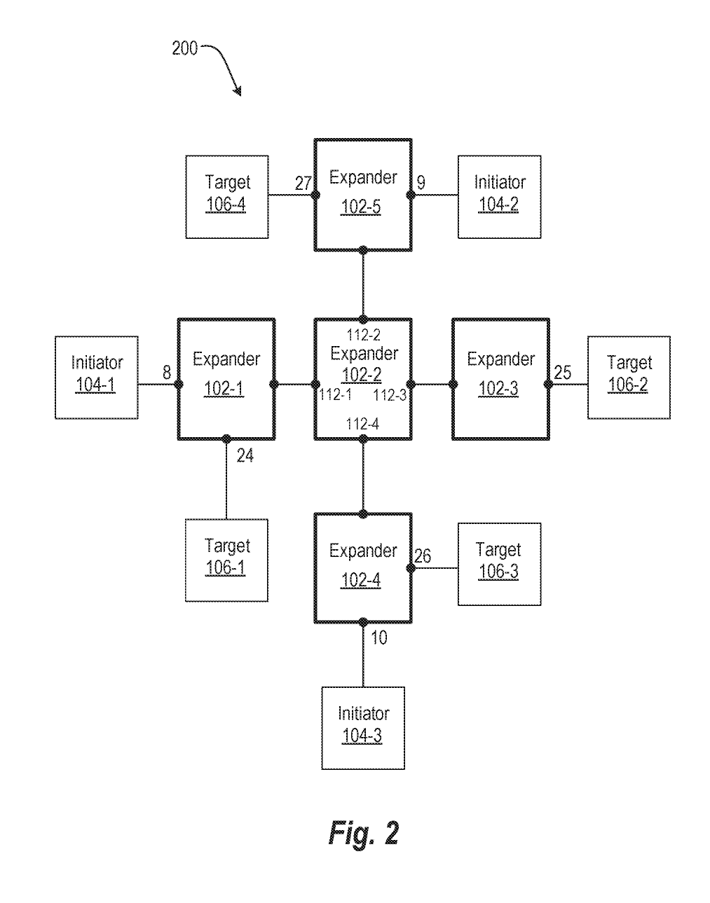

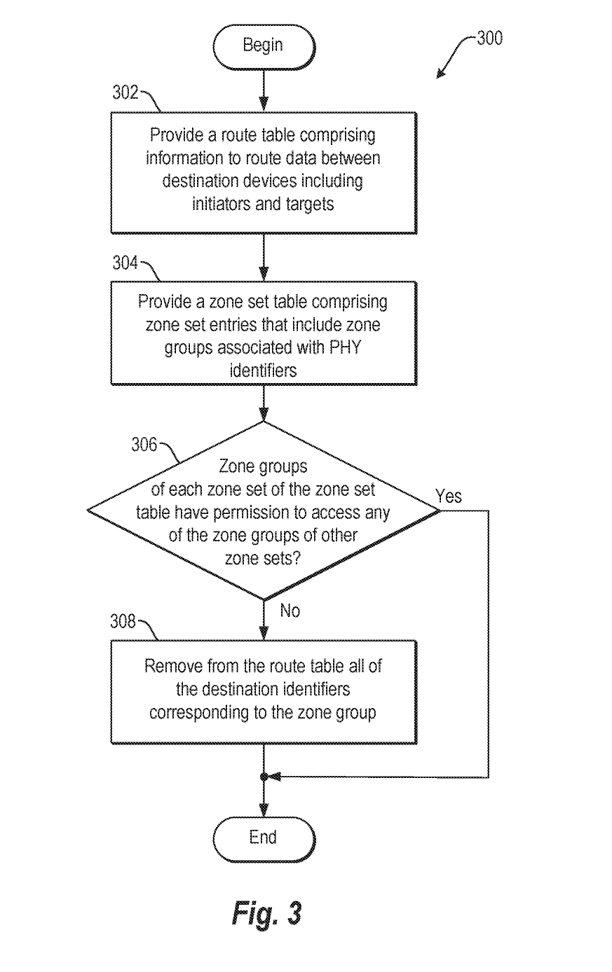

FIG. 2, FIG. 3 and FIG. 4 illustrate an example operation of the techniques of the present application. In particular, FIG. 2 provides an example block diagram of a system 200 with expanders to route data in accordance with the techniques of the present application. FIG. 3 is an example process flow diagram of a method 300 for expanders of FIG. 2 to route data in accordance with the techniques of the present application. FIG. 4 is a diagram of route information 400 of the expander of FIG. 2 and FIG. 3 to route data in accordance with the techniques of the present application.

The system 200 of FIG. 2 includes five expanders 102 (102-1 through 102-5) having similar functionality to expander 102 of system 100 of FIG. 1. For example, expanders 102 (102-1 through 102-5) include functionality similar to that of route management module 108 of expander 102 of FIG. 1. FIG. 2 shows five expanders 102 (102-1 through 102-5) interconnected as part of a network or fabric of expanders and destination devices including three initiators (104-1 through 104-3) and four targets (106-1 through 106-4). Some of the expanders are assigned zone groups which are shown as numbers labeled next to the port bubble on the outside of the expanders. For example, first expander 102-1 is shown with zone groups {8, 24}, second expander 102-2 is not shown with zone groups, third expander 102-3 is shown with a zone group {25}, fourth expander 102-4 is shown with zone groups {10, 26} and fifth expander 102-5 is shown with zone groups {9, 27}. It may be assumed that system 200 is configured as a SAS fabric or network environment with expanders 102, initiators 104 and targets 106 configured as SAS enabled devices that may operate according to SAS protocols and specification. However, it should be understood that system of 200 may employ the techniques of the present application with other protocols such as Fibre Channel, Ethernet and the like.

As explained below in further detail, the techniques of the present application help manage or reduce the number of entries in the route table thereby allowing expanders to make an efficient use of their memory resources. In one example, to illustrate operation, the techniques of the present application will be described in relation to expander 102-2. However, it should be understood that the configuration of system 200 is for illustrative purposes and that other arrangements may employed to implement the techniques of the present application.

The method may be begin at block 302, where expanders 102 may provide or generate respective route tables comprising information to route data through respective expanders and between initiators and targets. In one example, expander 102-2 includes functionality of route management module 108 described above in relation to FIG. 1. In particular, expander 102-2 is configured to generate route information 400 that includes initial route table 410, permission table 420, zone set table 430 and resultant route table 440 as explained in further detail below. It may be assumed that the devices of system 200 execute a power up sequence or process in which expanders 102, initiators 104 and targets 106 are powered up and initialized. During this power up sequence, expanders 102, initiators 104 and targets 106 perform a discovery process that includes functionality to determine the status of the system 200 including discovering which devices are directly and indirectly connected to the PHYs of the expanders, initiators and targets. To illustrate, it may be assumed that expander 102-2 is configured with PHYs 112 (112-1, 112-2, 112-3, 112-4) for providing connections to other devices of system 200. However, it should be understood that expander 102-2 may be configured with a different number of PHYs.

In one example, expander 102-2 executes a discovery process that includes functionality to generate and send discover commands such as SAS based REPORT GENERAL commands directed to PHYs 112 of expander 102-2 to determine or discover which devices are connected to the PHYs of expander 102-2. In some cases, expander 102-2 executes a discovery process that includes functionality to generate and send discover commands such as SAS based DISCOVER or DISCOVER LIST commands directed to devices such as other expanders, initiators and targets connected to PHYs 112 of expander 102-2 to determine or discover which devices are indirectly connected to expander 102-2. In response to such discover commands, expander 102-2 receives or gathers information about the devices that are both directly and indirectly connected to PHYs 112 of expander 102-2.

In one example, expander 102-2 generates initial route table 410 and populates the route table with information based on the information gathered from the response to the discover commands about the devices that are connected to PHYs 112 of the expander. The initial route table 410 includes information regarding path information to route data through expanders 102 and between destination devices including initiators 104 and targets 106. In one example, initial route table 410 includes entries such as destination identifiers 412 that indicate address information of corresponding destination devices including initiators 104 and targets 106 connected to the expander, entries of PHY identifiers 414 that indicate destination devices connected to corresponding PHYs of the expander, and entries of zone group information 416 that indicate permission or access information associated with destination devices.

For example, expander 102-2 determines from the response to the discover commands that initiator 104-1 is indirectly connected to PHY 112-1 through expander 102-1 and that the expander 102-1 is assigned a zone group value of 8. With this information, expander 102-2 populates the first row of initial route table 410 with information associated with initiator 104-1 that indicates that initiator 104-1 (destination identifier entry 412) is indirectly connected to PHY 112-1 (PHY identifier entry 414) through expander 102-1 and that expander 102-1 is assigned a zone group value of 8 (zone group entry 416). In a similar manner, expander 102-2 determines from the response to the discover commands with information about the other destination devices including initiators 104 (104-2, 104-3) and targets 106 (106-1, 106-2, 106-3, 106-4) that are connected to the expander. With this information, expander 102-2 populates the other rows of initial route table 410 with information about the other destination devices including initiators 104 (104-2, 104-3) and targets 106 (106-1, 106-2, 106-3, 106-4) that are connected to the expander. Although not shown, it should be understood that the other expanders 102-1, 102-3, 102-4, 102-5 include functionality to perform a discovery process and generate table information 400 in a manner similar as expander 102-2 described herein.

In one example, in addition to expanders 102 generating respective initial route tables 410, the expanders generate respective permission tables 420. For example, to illustrate, expander 102-2 includes functionality to generate permission table 420 which has entries of zone groups 422 and entries specifying permission to zone groups 424. The zone group entries 422 represent zone groups associated with the PHYs of destination devices such as targets and initiators. The permission to zone group entries 424 represents the zone groups that the zone groups of entries 422 have permission to access. In one example, this information may be manually provided by a user of the system such as system administrator or automatically by the system. In one example, in the first row of permission table 420, zone group 8 (zone group entry 422 of permission table 420) which is associated with PHY identifier 112-1 (see PHY identifier entry 414 of initial route table 410) has been assigned permission to access zone group 24 (permission zone group entry 424 of permission table 420).

The permission table 420 specifies which zone groups have permission to access other zone groups. For example, if destination device 104-3 (Initiator) intends to access destination device 106-2 (target), then the destination device 104-3 (Initiator) may proceed to access destination device 106-2 (target) since the zone group 8 associated destination device 104-3 has permission or access to the zone group 25 associated with destination device 106-2. In this case, data or traffic will flow through expander 102-2 and hence the entry for destination device 104-3 and destination device 106-2 is important since expander 102-2 may use the information of those entries to determine which PHYs 112 are necessary to forward the data or traffic through expander and between the initiator and target.

However, in another example, permission table 420 indicates that zone group 8 which is associated with destination device 104-1 (initiator) has permission to zone group 24 which is associated with destination device 106-1 (target). In this case, destination device 104-1 (initiator) is permitted to only access destination device 106-1 (target) through expander 102-2. In a similar manner, zone group 9 is associated with destination device 104-2 (initiator) and has permission to zone group 27 which is associated with destination device 106-4 (target). In this case, permission tables indicates table that destination device 104-2 (initiator) is permitted to only access destination device 106-4 (target). In both cases, expander 102-2 is not involved with communication between these devices and data or traffic would not flow through expander 102-2. Therefore, expander 102-2 may be configured to use the information from permission table 420 to drop or remove entries associated with 104-1 (initiator), 104-2 (initiator), 106-1 (target) and 106-4 (target). Therefore, expander generates initial route table 410 with 7 entries, and after the process of the present application the expander, removes 4 entries from the initial route table 410 resulting in 3 entries as shown in resultant route table 440, where the process is described below in further detail. As described below, these techniques help manage or reduce the number of entries in the route table thereby allowing expanders to make an efficient use of their memory resources.

Once expanders 102 have generated and populated respective permission tables 420, then processing proceeds to block 304 where the expanders 102 generate respective zone set tables 430 as described below.

At block 304, expanders 102 provide or generate zone set tables 430 comprising zone set entries that include zone groups associated with PHY identifiers. For example, expander 102-2 includes functionality to generate or provide a zone set table 430 comprising zone set entries 434 that include zone groups associated with destination identifier entries 432 which represents PHY identifiers of the expander. In one example, expander 102-2 generates zone set entries 434 based on zone group information gathered from response to discover commands and groups the zone groups associated with each of the PHY identifiers to form such zone sets. For example, in the first row of zone set table 430, first PHY identifier 112-1 (destination identifier entry 432) is associated with first zone set (zone set entry 434) comprising a zone group {8, 24}. Likewise, in the second row of zone set table 430, second PHY identifier 112-2 (destination identifier entry 432) is associated with a second zone set (zone set entry 434) comprising a zone group {9, 27}. In a similar manner, in the third row of zone set table 430, third PHY identifier 112-3 (destination identifier entry 432) is associated with a third zone set (zone set entry 434) comprising a zone group {25}. Finally, in the fourth row of zone set table 430, fourth PHY identifier 112-4 (destination identifier entry 432) is associated with a fourth zone set (zone set entry 434) comprising a zone group {10, 26}.

Once expanders 102 have generated and populated respective zone set tables 430, then processing proceeds to block 306 where the expanders check respective zone set tables 430 to determine whether to reduce unnecessary entries in initial route table 410 to reduce the size of the initial route table, as described below in further detail.

At block 306, expanders 102 check whether zone groups of each zone set of the respective zone set tables 430 have permission to access any of the zone groups of other zone sets. That is, in one example, expanders 102 define a zone group as having access to a zone set if it has access to at least one of the zone groups in that zone set. In addition, if the given zone group belongs to a zone set, it is said to have access to the zone set, since a zone group always has access to itself. For example, expander 102-2 includes functionality to check whether zone groups of each zone set of zone set table 430 has permission to access any of the zone groups of other zone sets. As an initial step in this process, expander 102-2 checks the first row of zone set table 430 and checks whether any of the zone groups of the first zone set {8, 24} has permission to access any of the zone groups of the second zone set {9, 27}, the zone group of the third zone set {25} or the zone groups of the fourth zone set {10, 26}. In this case, as a first step of the process, expander 102-2 checks permission table 420 to determine whether the zone groups of the first zone set {8, 24}, by checking permission zone group entry 422, has permission to access, by checking permission zone group entry 424, any of the zone groups of the second zone set {9, 27}, zone group of the third zone set {25}, zone groups of the fourth zone set {10, 26}. In this case, expander 102-2 determines that permission table 420 indicates that zone groups of first zone set {8, 24} do not have permission to access any of the zone groups of the second zone set {9, 27}, third zone set {25} or the fourth zone set {10, 26}. As a result, expander 102-2 proceeds to block 308 to remove from route table 410 all of the destination identifiers corresponding to that zone group, that is, destination identifiers associated with zone groups of the first zone set {8, 24}, as explained below in further detail.

At block 308, expanders 102 remove from the route table all the destination identifiers corresponding to that identified zone group. In this case, as explained above, expander 102-2 determines that permission table 420 indicates that zone groups of the first zone set {8, 24} do not have permission to access any of the zone groups of the second zone set {9, 27}, third zone set {25} or the fourth zone set {10, 26}. As a result, expander 102-2 removes from initial route table 410 all of the destination identifiers corresponding to that zone group, that is, destination identifiers associated with zone groups of the first zone set {8, 24}. In particular, expander 102-2 removes from initial route table 410 the first row (corresponding to destination identifier 104-1 entry) and the fourth row (corresponding to destination identifier 106-1 entry) as indicated by the diagonal lines of the first row and fourth row, resulting in reduction in table entries as shown in resultant route table 440.

The expanders 102 perform the process of block 306 of checking zone groups for each of the zone sets. For example, as explained above, as a first step of the process, expander 102-2 checked the first row of zone set table 430 which included comparing zone groups of the first zone set {8, 24} associated with PHY identifier 112-1 with the zone groups of the other zone sets {9, 27}, {25} and {10,26}. As result, expander 102-2 removed from initial route table 410 the destination identifier 104-1, 106-1 entries as indicated by the resulting in reduction in table entries as shown in resultant route table 440.

In the next step of the process, in this example, expander 102-2 checks the next zone set, in this case, the second row of zone set table 430 which includes zone groups of the second zone set {9, 27} and compares the zone group of the second zone set {9, 27} with the zone groups of the first zone set {8, 24}, the zone group of the third zone set {25} and the zone groups of the fourth zone set {10,26}. In this case, expander 102-2 checks permission table 420 to determine whether any of the zone groups of the second zone set {9, 27}, by checking zone group entry 422, has permission to access, by checking permission zone group entry 424, any of the zone groups of the first zone set {8, 24}, zone group of the third zone set {25}, zone groups of the fourth zone set {10, 26}. In this case, expander 102-2 determines that permission table 420 indicates that zone groups of the second zone set {9, 27} do not have permission to access any of the zone groups of the first zone set, third zone set or the fourth zone set. As a result, expander 102-2 removes from initial route table 410 all of the destination identifiers corresponding to that zone group, that is, destination identifiers associated with zone groups of the second zone set {9, 27}. In particular, expander 102-2 removes from initial route table 410 the second (corresponding to destination identifier 104-2) and the seventh row (corresponding to destination identifier 106-4) as indicated by the diagonal lines of the second row and seventh row of resultant route table 440.

In the next further step of the process, in this example, expander 102-2 checks the next zone set, in this case, the third row of zone set table 430 which includes zone group of the third zone set {25} and compares the zone group of the third zone set {25} with the zone groups of the first zone set {8, 24}, the zone groups of the second zone set {9, 27} and the zone groups of the fourth zone set {10,26}. In this case, expander 102-2 checks permission table 420 to determine whether the zone group of the third zone set {25}, by checking zone group entry 422, has permission to access, by checking permission zone group entry 424, any of the zone groups of the first zone set {8, 24}, zone group of the second zone set {9, 27} or zone groups of the fourth zone set {10, 26}. In this case, expander 102-2 determines that permission table 420 indicates that the zone group of the third zone set {25} does have permission to access the zone groups of the first zone set, second zone set or the fourth zone set. In particular, expander 102-2 determines that permission table 420 indicates that zone group of the third zone set {25} has access to the zone group 10 of fourth zone set {10, 26}. As a result, expander 102-2 does not remove from initial route table 410 the destination identifier corresponding to the zone group, that is, zone group of the fourth zone set {10, 26}. In particular, expander 102-2 leaves the third row (corresponding to initiator identifier 104-3), fifth row (corresponding to destination identifier 106-2) and sixth row (corresponding to destination identifier 106-3) as indicated in resultant route table 440.

In the next additional step of the process, in this example, expander 102-2 checks the next zone set, in this case, the fourth row of zone set table 430 which includes zone groups of the fourth zone set {10, 26} and compares the zone groups of the fourth zone set {10, 26} with the zone groups of the first zone set {8, 24}, the zone groups of the second zone set {9, 27} and the zone group of the third zone set {25}. In this case, expander 102-2 checks permission table 430 to determine whether any of the zone groups of the fourth zone set {10, 26}, by checking zone group entry 422, has permission to access, by checking permission zone group entry 424, any of the zone groups of the first zone set {8, 24}, zone group of the second zone set {9, 27}, zone group of the third zone set {25}. In this case, expander determines that permission table 420 indicates that zone groups of the fourth zone set {10, 26} do have permission to access any of the zone groups of the first zone set, second zone set or the third zone set. In particular, expander 102-2 determines that permission table 420 indicates that zone group of the fourth zone set {10, 26} has access to the zone group 25 of third zone set {25}. As a result, expander 102-2 leaves in route table 410 all of the destination identifiers corresponding to that zone group, that is, zone groups of the second zone set {10, 26}. In particular, expander 102-2 leaves the third row (corresponding to destination identifier 104-3), fifth row (corresponding to destination identifier 106-2), and the sixth row (corresponding to destination identifier 106-3) as indicated in resultant route table 440.

The above techniques illustrate one example of the techniques of the present application and it should be understood that other examples are possible to implement the techniques of the present application. As explained above, if an expander determines that a destination device has no permission or access to another zone set, then an entry for the destination device no longer needs to be in the route table since no request will be received by the expander from that device. That is, the expander may check the first zone set, and for every zone group in that zone set, check to determine whether the zone group has access to any of the other zone sets. If so, if the route table does not include the entry, then the expander may enter into the route table entries of all the destination devices corresponding to that zone group. In another example, if the route table has the entries, then the expander may remove from route table entries of all the destination devices corresponding to that zone group. In another example, the expander may enter into the route table entries of all the destination devices corresponding to the zone groups in the zone set, which the given zone group has the permission to access.

In this manner, the techniques of the present application help manage or reduce the number of entries in the route table thereby allowing expanders to make an efficient use of their memory resources. In another example, the techniques may optimize the size of a route table using the permission table by avoiding unnecessary entries. In this way, the expander can make more efficient use of available memory resources to store the route table which may be a relatively costly or scarce resource in general and may allow growth in storage networks such as SAS fabrics.

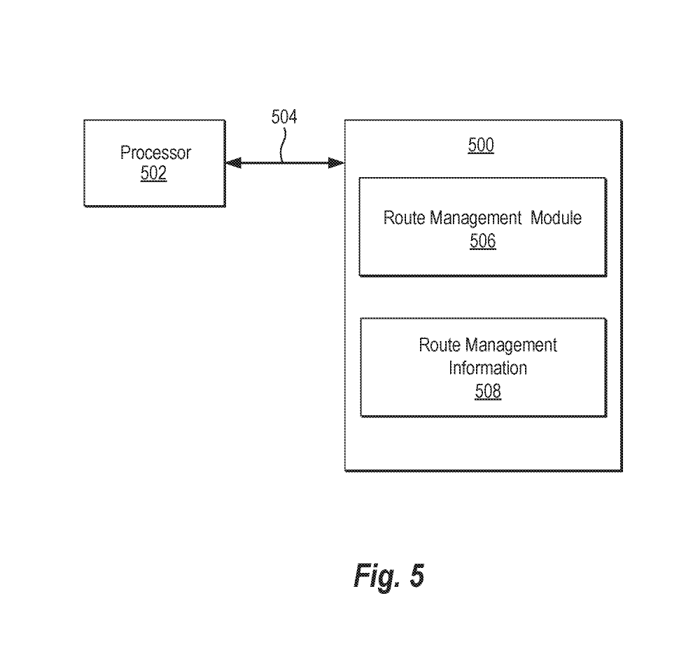

FIG. 5 is an example block diagram showing a non-transitory, computer-readable medium that stores instructions for operating an expander to route data in accordance with the techniques of the present application. The non-transitory, computer-readable medium is generally referred to by the reference number 500 and may be included in expander 102 of the SAS fabric described in relation to functionality of expanders 102 described herein. The non-transitory, computer-readable medium 500 may correspond to any typical storage device that stores computer-implemented instructions, such as programming code or the like. For example, the non-transitory, computer-readable medium 500 may include one or more of a non-volatile memory, a volatile memory, and/or one or more storage devices. Examples of non-volatile memory include, but are not limited to, electrically erasable programmable read only memory (EEPROM) and read only memory (ROM). Examples of volatile memory include, but are not limited to, static random access memory (SRAM), and dynamic random access memory (DRAM). Examples of storage devices include, but are not limited to, hard disk drives, compact disc drives, digital versatile disc drives, optical drives, and flash memory devices.

A processor 502 generally retrieves and executes the instructions stored in the non-transitory, computer-readable medium 500 to operate the SAS expander in accordance an example. In an example, the tangible, machine-readable medium 500 may be accessed by the processor 502 over a bus 504. A first region 506 of the non-transitory, computer-readable medium 500 may include route management module functionality as described herein. A second region 508 of the non-transitory, computer-readable medium 500 may include route management information as described herein.

Although shown as contiguous blocks, the software components may be stored in any order or configuration. For example, if the non-transitory, computer-readable medium 500 is a hard drive, the software components may be stored in non-contiguous, or even overlapping, sectors.

What is claimed is:

1. An expander comprising:
a route table comprising information to route data between destination devices including initiators and targets, wherein the route table includes entries of destination identifiers to indicate address information of corresponding destination devices connected to expanders, PHY identifiers to indicate destination devices connected to corresponding PHYs of the expanders, and zone group information to indicate permission associated with the destination devices;
a zone set table comprising zone set entries that include zone groups associated with the PHY identifiers; and
a route management module to:
check whether zone groups of each zone set of the zone set table has permission to access any of the zone groups of other zone sets, and
if any of the zone groups of each zone set of the zone set table does not have permission to access any of the zone groups of other zone sets, then remove from the route table all the destination identifiers corresponding to that zone group.

2. The expander of claim 1, wherein the route management module is configured to respond to requests from initiators to receive data from the initiators and to route the received data through the expanders and to store the data to the targets, and respond to requests from initiators to retrieve data from the targets and to route the retrieved data through the expanders and to return the retrieved data back to the initiators.

3. The expander of claim 1, wherein the route management module is configured to identify targets, initiators and other expanders connected to PHYs of the expander and to store the identification information to the route table.

4. The expander of claim 1, wherein the route management module is configured to generate a permission table that includes assignment of zone group information to targets that identify initiators that are granted permission to access targets.

5. The expander of claim 1, wherein the route management module is configured to generate PHY identifiers that represent PHYs of the expanders through which data is to be routed between targets and initiators.

6. A method of operating an expander comprising:
providing a route table comprising information to route data between destination devices including initiators and targets, wherein the route table includes entries of destination identifiers to indicate address information of corresponding destination devices connected to expanders, PHY identifiers to indicate destination devices connected to corresponding PHYs of the expanders, and zone group information to indicate permission associated with the destination devices;
providing a zone set table comprising zone set entries that include zone groups associated with the PHY identifiers; and
using a route management module to check whether zone groups of each zone set of the zone set table has permission to access any of the zone groups of other zone sets, and if any of the zone groups of each zone set of the zone set table does not have permission to access any of the zone groups of other zone sets, then remove from the route table all the destination identifiers corresponding to that zone group.

7. The method of claim 6, further comprising responding to requests from initiators to receive data from the initiators and routing the received data through the expanders and storing the data to the targets, and responding to requests from initiators to retrieve data from the targets and routing the retrieved data through the expanders and returning the retrieved data back to the initiators.

8. The method of claim 6, further comprising identifying targets, initiators and other expanders connected to PHYs of the expanders and storing the identification information to the route table.

9. The method of claim 6, further comprising generating a permission table that includes assignment of zone group information to targets that identify initiators that are granted permission to access targets.

10. The method of claim 6, further comprising generating PHY identifiers that represent PHYs of the expanders through which data is to be routed between targets and initiators.

11. A non-transitory computer-readable medium having computer executable instructions stored thereon to operate an expander, the instructions are executable by a processor to:
generate a route table comprising information to route data between destination devices including initiators and targets, wherein the route table includes entries of destination identifiers to indicate address information of corresponding destination devices connected to expanders, PHY identifiers to indicate destination devices connected to corresponding PHYs of the expanders, and zone group information to indicate permission associated with the destination devices;
generate a zone set table comprising zone set entries that include zone groups associated with the PHY identifiers; and
check whether zone groups of each zone set of the zone set table has permission to access any of the zone groups of other zone sets, and if any of the zone groups of each zone set of the zone set table does not have permission to access any of the zone groups of other zone sets, then remove from the route table all the destination identifiers corresponding to that zone group.

12. The computer readable medium of claim 11 further comprising instructions that if executed cause a processor to:
respond to requests from initiators to receive data from the initiators and to route the received data through the expanders and to store the data to the targets; and
respond to requests from initiators to retrieve data from the targets and to route the retrieved data through the expanders and to return the retrieved data back to the initiators.

13. The computer readable medium of claim 11 further comprising instructions that if executed cause a processor to:
identify targets, initiators and other expanders connected to PHYs of the expander and to store the identification information to the route table.

14. The computer readable medium of claim 11 further comprising instructions that if executed cause a processor to:
generate PHY identifiers that represent PHYs of the expanders through with traffic is to be routed between targets and initiators.

15. The computer readable medium of claim 11 further comprising instructions that if executed cause a processor to:
generate a permission table that includes assignment of zone group information to targets that identify initiators that are granted permission to access targets.
